(19) United States
(12) Patent Application Publication
(10) Pub. No.: US 2022/0176642 A1
(43) Pub. Date: Jun. 9, 2022

(54) BONDING METHOD, AND HIGH-FREQUENCY DIELECTRIC HEATING ADHESIVE SHEET

(71) Applicant: LINTEC orporation, Tokyo (JP)

(72) Inventors: Haruka SASAKI, Itabashioku, Tokyo (JP); Takuto AOKI, Itabashioku, Tokyo (JP); Naoki TAYA, Itabashioku, Tokyo (JP)

(21) Appl. No.: 17/599,509

(22) PCT Filed: Mar. 16, 2020
(86) PCT No.: PCT/JP2020/011325

§ 371 Date: Sep. 28, 2021

(30) Foreign Application Priority Data
Mar. 29, 2019 (JP) 2019-068489

(51) Int. Cl. B29C 65/48; B29C 35/12

(52) U.S. Cl. CPC B29C 65/4855; B29C 65/4835; B29C 65/4885; B29K 2509/02; B29K 2995/0006; B29K 2995/0046; B29K 2995/0063; B29C 35/12

(57) ABSTRACT

A bonding method for bonding an adherend with a high-frequency dielectric heating adhesive sheet is provided. The adherend includes a fluorine-containing surface at least containing fluorine on a surface thereof. The high-frequency dielectric heating adhesive sheet includes a high-frequency dielectric adhesive layer including a thermoplastic resin and a dielectric filler. A surface free energy of the high-frequency dielectric adhesive layer is in a range from 15 mJ/m² to 30 mJ/m². A melting point of the high-frequency dielectric adhesive layer is in a range from 110 degrees C. to 300 degrees C. The bonding method includes bringing the fluorine-containing surface of the adherend into contact with the high-frequency dielectric adhesive layer and applying a high-frequency wave to the high-frequency dielectric adhesive layer to bond the high-frequency dielectric heating adhesive sheet to the fluorine-containing surface.

### TECHNICAL FIELD

The present invention relates to a bonding method and a high-frequency dielectric heating adhesive sheet.

### BACKGROUND ART

Fluorine resins are excellent in weatherability, stain-proofness, chemical resistance, and heat resistance. However, it is difficult to bond a component containing a fluorine resin with another component. Accordingly, studies for an adhesion method of fluorine resin have been made.

Patent Literature 1 discloses an adhesion method of fluorine resin, in which a surface of a fluorine resin component is subjected to a corona treatment and is further applied with a primer, and a thermoplastic polyester or polyamide is used as an adhesive.

### CITATION LIST

### Patent Literature(s)

Patent Literature 1 JP 63-009533 B2

### SUMMARY OF THE INVENTION

### Problems to be Solved by the Invention

For adhesion of fluorine resin, for instance, it is typically necessary to apply a surface treatment on the surface of fluorine resin (e.g. subjecting the surface of fluorine resin to a corona treatment or applying a primer on the surface of fluorine resin) as disclosed in Patent Literature 1.

An object of the invention is to provide a bonding method capable of firmly bonding a component with an adherend containing fluorine without applying a pretreatment on a surface of the adherend and a high-frequency dielectric heating adhesive sheet used in the bonding method.

### Means for Solving the Problems

According to an aspect of the invention, there is provided a bonding method for bonding an adherend with a high-frequency dielectric heating adhesive sheet, in which the adherend includes a fluorine-containing surface that contains at least fluorine on a surface thereof, the high-frequency dielectric heating adhesive sheet includes a high-frequency dielectric adhesive layer, the high-frequency dielectric heating adhesive sheet includes a high-frequency dielectric adhesive layer, the high-frequency dielectric adhesive layer includes a thermoplastic resin (A) and a dielectric filler (B), a surface free energy of the high-frequency dielectric adhesive layer is in a range from 15 mJ/m2 to 30 mJ/m2, and a melting point of the high-frequency dielectric adhesive layer is in a range from 110 degrees C. to 300 degrees C., the method including: bringing the fluorine-containing surface of the adherend into contact with the high-frequency dielectric adhesive layer; and applying a high-frequency wave to the high-frequency dielectric adhesive layer to bond the high-frequency dielectric heating adhesive sheet to the fluorine-containing surface.

In the bonding method according to the above aspect of the invention, it is preferable that the dielectric filler (B) is zinc oxide.

In the bonding method according to the above aspect of the invention, it is preferable that the thermoplastic resin (A) is a fluorinated thermoplastic resin containing fluorine.

In the bonding method according to the above aspect of the invention, it is preferable that a content of the dielectric filler (B) in the high-frequency dielectric adhesive layer is in a range from 3 volume % to 50 volume %.

In the bonding method according to the above aspect of the invention, it is preferable that a difference T1−T2 between a melting point T1 of the adherend and a melting point T2 of the high-frequency dielectric adhesive layer is in a range from 10 degrees C. to 90 degrees C.

In the bonding method according to the above aspect of the invention, it is preferable that a tensile rupture elongation of the high-frequency dielectric heating adhesive sheet is in a range from 10% to 600%.

In the bonding method according to the above aspect of the invention, it is preferable that Young's modulus of the high-frequency dielectric heating adhesive sheet is in a range from 400 MPa to 3000 MPa.

In the bonding method according to the above aspect of the invention, it is preferable that a density of the high-frequency dielectric heating adhesive sheet is in a range from 1.5 g/cm³ to 3.5 g/cm³.

In the bonding method according to the above aspect of the invention, it is preferable that a thickness of the adherend is in a range from 0.01 mm to 2 mm.

In the bonding method according to the above aspect of the invention, it is preferable that the adherend and another adherend different from the adherend are bonded through the high-frequency dielectric adhesive layer.

In the bonding method according to the above aspect of the invention, it is preferable that the another adherend also includes a fluorine-containing surface that contains at least fluorine on a surface thereof.

In the bonding method according to the above aspect of the invention, it is preferable that a high-frequency wave in a range from 1 kHz to 300 MHz is applied to the high-frequency dielectric adhesive layer.

In the bonding method according to the above aspect of the invention, it is preferable that an application time of the high-frequency wave is in a range from one second to 60 seconds.

In the bonding method according to the above aspect of the invention, it is preferable that a bonded product provided by bonding the adherend and the high-frequency dielectric heating adhesive sheet is used outdoors.

According to an aspect of the invention, there is provided a high-frequency dielectric heating adhesive sheet used in the bonding method according to the above aspect of the invention.

According to the above aspect of the invention, there is provided a bonding method capable of firmly bonding a component with an adherend made of a fluorine material without applying a pretreatment on a surface of the adherend.

Further, according to the above aspect of the invention, there is provided a high-frequency dielectric heating adhesive sheet used in the bonding method.

### BRIEF EXPLANATION OF DRAWINGS

FIG. 1 is a schematic cross-sectional view of an assembly according to a first exemplary embodiment.

FIG. 2 illustrates a dielectric heating treatment performed using a dielectric heating adhesion device in the first exemplary embodiment.

FIG. 3 is a schematic cross-sectional view of an assembly according to a modification.

FIG. 4 is a schematic cross-sectional view of an assembly according to another modification.

### DESCRIPTION OF EMBODIMENT(S)

### First Exemplary Embodiment

A bonding method according to the present exemplary embodiment is a method for bonding an adherend with a high-frequency dielectric heating adhesive sheet.

### Adherend

The adherend according to the present exemplary embodiment has a fluorine-containing surface that contains at least fluorine on a surface thereof. Accordingly, when an entirety of the adherend according to the present exemplary embodiment is made of a material containing fluorine, the surface of the adherend defines the fluorine-containing surface. Alternatively, when the adherend has a part made of a material containing fluorine and a part made of a material not containing fluorine, it is only necessary that the part made of the material containing fluorine is exposed at a part of, parts of, or an entirety of the surface of the adherend.

The material containing fluorine is preferably a fluorine resin.

The fluorine resin is not specifically limited as long as containing fluorine.

Examples of the fluorine resin include polytetrafluoroethylene resin (sometimes abbreviated as PTFE hereinafter), tetrafluoroethylene-perfluoroalkoxy ethylene copolymer resin (sometimes abbreviated as PFA hereinafter), tetrafluoroethylene-hexafluoro propylene copolymer resin (sometimes abbreviated as FEP hereinafter), polyvinyl fluoride (sometimes abbreviated as PVF), polyvinylidene fluoride (sometimes abbreviated as PVdF hereinafter), tetrafluoroethylene-ethylene copolymer resin (sometimes abbreviated as ETFE hereinafter), polychlorotrifluoro ethylene (sometimes abbreviated as PCTFE hereinafter), and chlorotrifluoroethylene.ethylene copolymer (sometimes abbreviated as ECTFE hereinafter). The fluorine resin is preferably ETFE in view of its easy capability of adjusting processability by changing the ethylene content while keeping the fluorine content.

The shape of the adherend according to the present exemplary embodiment is not specifically limited. Examples of the adherend according to the present exemplary embodiment include a fluorine resin molding product produced by molding the fluorine resin and a sheet having a layer containing the fluorine resin on a surface thereof. When the adherend is the sheet having a layer containing the fluorine resin (fluorine-resin-containing layer) on a surface thereof, the adherend preferably has a base material (e.g. a polyester film) and the fluorine-resin-containing layer provided on the base material. Alternatively and/or additionally, in view of strength, the adherend also preferably has a glass-fiber woven fabric and a fluorine resin containing layer formed by coating the glass-fiber woven fabric with the fluorine resin.

A thickness of the adherend according to the present exemplary embodiment is preferably 0.01 mm or more, more preferably 0.05 mm or more, further preferably 0.1 mm or more in order to reduce a damage on the adherend during the high-frequency dielectric heating adhesion.

The thickness of the adherend according to the present exemplary embodiment is preferably 2 mm or less, more preferably 1.5 mm or less, further preferably 1 mm or less for the convenience of efficient bonding.

### High-Frequency Dielectric Heating Adhesive Sheet

The high-frequency dielectric heating adhesive sheet used in the bonding method according to the present exemplary embodiment will be described below.

The high-frequency dielectric heating adhesive sheet according to the present exemplary embodiment includes a high-frequency dielectric adhesive layer. The high-frequency dielectric adhesive layer contains a thermoplastic resin (A) and a dielectric filler (B). The thermoplastic resin (A) will be sometimes referred to as a component A hereinafter. The dielectric filler (B) will be sometimes referred to as a component B hereinafter.

The high-frequency dielectric heating adhesive sheet according to the present exemplary embodiment optionally consists solely of the high-frequency dielectric adhesive layer. It should be noted that the high-frequency dielectric heating adhesive sheet of the invention does not necessarily consist solely of the high-frequency dielectric adhesive layer but the high-frequency dielectric heating adhesive sheet has a laminated layer(s) other than the high-frequency dielectric adhesive layer in some modifications.

As described above, the term “high-frequency dielectric heating adhesive sheet,” which optionally consists solely of the high-frequency dielectric adhesive layer, is sometimes interchangeable with the term “high-frequency dielectric adhesive layer” herein.

### High-Frequency Dielectric Adhesive Layer

In the present exemplary embodiment, a surface free energy of the high-frequency dielectric adhesive layer is in a range from 15 mJ/m² to 30 mJ/m², and a melting point of the high-frequency dielectric adhesive layer is in a range from 110 degrees C. to 300 degrees C.

### Surface Free Energy

The surface free energy of the high-frequency dielectric adhesive layer is preferably 16 mJ/m² or more, more preferably 17 mJ/m² or more.

The surface free energy of the high-frequency dielectric adhesive layer is preferably 28 mJ/m² or less, more preferably 26 mJ/m² or less, further preferably 24 mJ/m² or less.

A measurement method of the surface free energy of the high-frequency dielectric adhesive layer is as follows.

The surface free energy (mJ/m²) of the high-frequency dielectric adhesive layer is calculated according to the Kitazaki-Hata theory based on measurements of contact angles (measurement temperature: 25 degrees C.) of various liquid drops.

The surface free energy (mJ/m²) is specifically obtained as follows. Initially, the contact angles (measurement temperature: 25 degrees C.) of diiodomethane, 1-bromonaphthalene, and distilled water in a form of liquid drops are measured using DM-70 manufactured by Kyowa Interface Science Co., Ltd. according to Sessile drop method as specified by JIS R 3257: 1999. Then, the surface free energy (mJ/m²) is calculated according to the Kitazaki-Hata theory based on the measurements of the contact angles.

### Melting Point

The melting point of the high-frequency dielectric adhesive layer is preferably 130 degrees C. or more, more preferably 150 degrees C. or more, further preferably 180 degrees C. or more.

The melting point of the high-frequency dielectric adhesive layer is preferably 270 degrees C. or less, more preferably 245 degrees C. or less, further preferably 220 degrees C. or less, further more preferably 210 degrees C. or less.

With the surface free energy and the melting point within the above range, excellent adhesion force can be provided for an adherend whose surface contains fluorine.

### Thermoplastic Resin (A)

The type of the thermoplastic resin (A) is not specifically limited.

### Fluorinated Thermoplastic Resin

The thermoplastic resin (A) is preferably a fluorinated thermoplastic resin containing fluorine. The thermoplastic resin (A) containing the fluorinated thermoplastic resin exhibits improved adhesion force with respect to the fluorine-containing surface of the adherend. Further, the fluorinated thermoplastic resin is a resin excellent in weatherability, stain-proofness, chemical resistance, and heat resistance. Accordingly, an assembly formed by bonding an adherend and the high-frequency dielectric heating adhesive sheet is suitable for outdoor use. Examples of the assembly for the outdoor use include roof components and wall components.

The fluorinated thermoplastic resin is preferably a copolymer resin having a repeating unit including a fluorine atom and a repeating unit including no fluorine atom. The fluorinated thermoplastic resin in a form of the copolymer resin is capable of improving adhesivity with a surface of an adherend, lowering the melting point of the high-frequency dielectric adhesive layer, and improving dispersibility of the dielectric filler (B) in the high-frequency dielectric adhesive layer by appropriate selection of the type and adjustment of a ratio of the repeating unit including no fluorine atom in the copolymer resin. When the fluorinated thermoplastic resin is a copolymer resin, the repeating unit including no fluorine atom is preferably an olefin unit, more preferably an ethylene unit.

The fluorinated thermoplastic resin is also preferably a fluorine resin (e.g. PTFE, PFA, FEP, PVF, PVdF, ETFE, PCTFE, and ECTFE) described with reference to the adherend.

The fluorinated thermoplastic resin is more preferably a tetrafluoroethylene-ethylene copolymer resin (ETFE). It is believed that the melting point of the fluorinated thermoplastic resin can be lowered by increasing the ratio of the ethylene part including no fluorine atom in the copolymer resin.

In another aspect of the present exemplary embodiment, in view of good meltability, a predetermined level of heat resistance, etc., the thermoplastic resin (A) is also optionally at least one resin selected from the group consisting of a polyolefin resin, a polyolefin resin having a polar portion, a styrene resin, a polyacetal resin, a polycarbonate resin, a polyacrylic resin, a polyamide resin, a polyimide resin, a polyvinyl acetate resin, a phenoxy resin, and a polyester resin. The high-frequency dielectric adhesive layer optionally contains the above resin(s), but preferably does not contain the above resin(s) in view of adhesivity to an adherend.

### Melting Point

The melting point of the thermoplastic resin (A) is in a range from 110 degrees C. to 300 degrees C.

The melting point of the thermoplastic resin (A) is preferably 130 degrees C. or more, more preferably 150 degrees C. or more, further preferably 180 degrees C. or more. The high-frequency dielectric adhesive layer exhibits excellent heat resistance with the use of the thermoplastic resin (A) whose melting point is 110 degrees C. or more.

The melting point of the thermoplastic resin (A) is preferably 270 degrees C. or less, more preferably 245 degrees C. or less, further preferably 220 degrees C. or less, especially preferably 210 degrees C. or less. The thermoplastic resin (A) with a melting point of 300 degrees C. or less prevents the adherend from being thermally damaged which may otherwise be caused by excessively increased melt temperature during the high-frequency induction heating treatment.

The measurement method of the melting point herein is as described in later-described Examples.

### Softening Temperature

The softening temperature of the thermoplastic resin (A) is preferably 150 degrees C. or more, more preferably 165 degrees C. or more, further preferably 180 degrees C. or more.

The softening temperature of the thermoplastic resin (A) is preferably 350 degrees C. or less, more preferably 300 degrees C. or less, further preferably 280 degrees C. or less, further more preferably 260 degrees C. or less, still further preferably 240 degrees C. or less, especially preferably 220 degrees C. or less.

The high-frequency dielectric adhesive layer exhibits improved heat resistance with the use of the thermoplastic resin (A) whose softening temperature is 150 degrees C. or more. When an assembly provided by bonding the high-frequency dielectric heating adhesive sheet according to the present exemplary embodiment and an adherend is installed outdoors, the adherend and the high-frequency dielectric heating adhesive sheet are likely to be kept bonded even in a high-temperature (e.g. in mid-summer).

With a softening temperature of the thermoplastic resin (A) of 350 degrees C. or less, a stable bonding strength is likely to be exhibited within a short time.

The measurement method of the softening temperature herein is as described in later-described Examples.

### Density

The density of the thermoplastic resin (A) according to the present exemplary embodiment is preferably 1.2 g/cm³ or more, more preferably 1.5 g/cm³ or more, further preferably 1.7 g/cm³ or more.

The density of the thermoplastic resin (A) according to the present exemplary embodiment is preferably 2.3 g/cm³ or less, more preferably 2.1 g/cm³ or less, further preferably 1.9 g/cm³ or less, further more preferably 1.8 g/cm³ or less.

With a density of the thermoplastic resin (A) of 1.2 g/cm³ or more, the sheet is more easily restrained from being flapped while the sheet is molded through a roll-to-roll process.

With a density of the thermoplastic resin (A) of 2.3 g/cm³ or less, the high-frequency dielectric heating adhesive sheet is not likely to sag due to self-weight, and thus peeling at an interface between the sheet and the adherend is not likely to be caused.

With a density of the thermoplastic resin (A) of 2.3 g/cm³ or less, an increase in the weight of the high-frequency dielectric heating adhesive sheet and, consequently, in the weight of the assembly can be restrained. With the assembly whose increase in the weight is restrained, workability during a construction work using the assembly is easily improvable.

The density of the thermoplastic resin (A) and the density of the high-frequency dielectric heating adhesive sheet can be measured in accordance with Method A (water displacement method) as specified in JIS K 7112: 1999.

### Flow Start Temperature

The flow start temperature of the thermoplastic resin (A) is preferably 70 degrees C. or more, more preferably 110 degrees C. or more, further preferably 150 degrees C. or more, further more preferably 180 degrees C. or more.

The flow start temperature of the thermoplastic resin (A) is preferably 380 degrees C. or less, more preferably 300 degrees C. or less, further preferably 260 degrees C. or less, further more preferably 230 degrees C. or less.

With a flow start temperature of the thermoplastic resin (A) of 70 degrees C. or more, excellent heat resistance is likely to be exhibited.

With a flow start temperature of the thermoplastic resin (A) of 380 degrees C. or less, favorable adhesivity is likely to be exhibited in a short time.

The measurement method of the flow start temperature of the thermoplastic resin (A) herein is as described in later-described Examples.

### Dielectric Filler (B)

The dielectric filler (B) preferably generates heat by applying a high-frequency wave ranging from 1 kHz to 300 MHz. Further, the dielectric filler (B) is preferably a high-frequency-wave absorbing filler having a high dielectric loss factor at which heat can be generated by applying a high-frequency wave of, for instance, 27.12 MHz or 40.68 MHz.

Suitable examples of the dielectric filler (B) include a single one or a combination of two or more of zinc oxide, silicon carbide (SiC), anatase-type titanium oxide, barium titanate, barium titanate zirconate, lead titanate, potassium niobate, rutile-type titanium oxide, hydrated aluminum silicate, inorganic substances having crystallization water such as hydrated aluminosilicate salt of alkali metal, and inorganic substances having crystallization water such as hydrated aluminosilicate salt of alkaline earth metal.

The dielectric filler (B) is preferably a metal oxide, more preferably zinc oxide. Zinc oxide as the dielectric filler (B) exhibits a high dielectric property and has a low impact on the thermoplastic resin (A). Further, zinc oxide has a large variety of types, and can thus be selected from various shapes and sizes. In addition, with the use of the dielectric filler (B) of zinc oxide, adhesive and mechanical properties of the high-frequency dielectric heating adhesive sheet are improvable in accordance with an application thereof.

Zinc oxide as the dielectric filler (B) is easily blended in the thermoplastic resin (A) as an adhesive component. Accordingly, even when the content of zinc oxide in the high-frequency dielectric adhesive layer is relatively small, excellent heat-generation performance can be exhibited during a predetermined dielectric heating treatment as compared with a high-frequency dielectric heating adhesive sheet containing any other dielectric filler than zinc oxide.

Accordingly, the high-frequency dielectric heating adhesive sheet, whose high-frequency dielectric adhesive layer contains zinc oxide as the dielectric filler (B), exhibits excellent fusibility or adhesiveness to an adherend having a fluorine-containing surface during a dielectric heating treatment.

The high-frequency dielectric adhesive layer according to the present exemplary embodiment preferably does not contain a conductive substance. Examples of the conductive substance include carbon, carbon compounds (e.g. carbon black) whose main component is carbon, and metals. The content of the conductive substance, if present, is preferably 5 mass % or less, more preferably 1 mass % or less, further preferably 0.1 mass % or less, further more preferably 0 mass % based on a total mass of the high-frequency dielectric adhesive layer. With a content of the conductive substance in the high-frequency dielectric adhesive layer of 5 mass % or less, electric breakdown is unlikely to occur in the high-frequency dielectric adhesive layer during the dielectric heating treatment, thereby easily inhibiting carbonization of an adhered portion and the adherend.

### Average Particle Size

The average particle size (median radius, D50) of the dielectric filler (B) measured in accordance with JIS Z 8819-2: 2001 is preferably 1 μm or more, more preferably 2 μm or more, further preferably 3 μm or more, further more preferably 5 μm or more.

The average particle size (median radius, D50) of the dielectric filler (B) measured in accordance with JIS Z 8819-2: 2001 is preferably 50 μm or less, more preferably 30 μm or less, further preferably 25 μm or less, further more preferably 20 μm or less, still further preferably 15 μm or less.

When the average particle size of the dielectric filler (B) is excessively small, inversion motion of particles when a high-frequency wave is applied is retarded, so that dielectric heating adhesiveness is excessively lowered to possibly make it difficult to achieve firm adhesion with an adherend.

In contrast, in accordance with an increase in the average particle size of the dielectric filler (B), polarizable distance inside the filler also increases. Accordingly, the degree of polarization is increased to intensify inversion motion at the time of applying a high-frequency wave, thereby improving dielectric heating adhesiveness.

Accordingly, when the average particle size of the dielectric filler (B) is 1 μm or more, though depending on the type of the filler, the distance for polarization inside the filler is not excessively reduced, so that decrease in the degree of polarization can be inhibited. Thus, excessive increase in the time required for bonding can be inhibited.

When the average particle size of the dielectric filler (B) is excessively large, because of small distance between neighboring dielectric fillers and consequent effect of electrical charge of the neighboring dielectric fillers, inversion motion of the particles when a high-frequency wave is applied is retarded to cause excessive decrease in the dielectric heating adhesiveness, sometimes making it difficult that adherends tightly adhere to each other.

With an average particle size of the dielectric filler (B) of 50 μm or less, excessive decrease in the dielectric heating adhesiveness and/or difficulty in achieving firm adhesion between adherends can be inhibited. With an average particle size of the dielectric filler (B) of 50 μm or less, deterioration in moldability of the high-frequency dielectric adhesive layer can be inhibited.

The average particle size (median radius, D50) of zinc oxide as the dielectric filler (B) measured in accordance with JIS Z 8819-2: 2001 is preferably 1 μm or more, more preferably 2 μm or more, further preferably 3 μm or more, further more preferably 5 μm or more.

The average particle size (median radius, D50) of zinc oxide as the dielectric filler (B) measured in accordance with JIS Z 8819-2: 2001 is preferably 30 μm or less, more preferably 25 μm or less, further preferably 20 μm or less, further more preferably 15 μm or less.

It should be noted that the average particle size of the dielectric filler (B) is preferably smaller than the thickness of the high-frequency dielectric adhesive layer.

A volume average particle size, which is the average particle size of the dielectric filler herein, is measured as follows. A particle size distribution of the dielectric filler is measured by a laser diffractive scattering method. Based on the result of the particle size distribution measurement, the volume average particle size is calculated in accordance with JIS Z 8819-2: 2001.

### Volume Content

The high-frequency dielectric heating adhesive sheet according to the present exemplary embodiment preferably contains 3 volume % or more, more preferably 10 volume % or more, further preferably 15 volume % or more of the dielectric filler (B) in the high-frequency dielectric adhesive layer.

The high-frequency dielectric heating adhesive sheet according to the present exemplary embodiment preferably contains 50 volume % or less, more preferably 40 volume % or less, further preferably 35 volume % or less, further more preferably 25 volume % or less of the dielectric filler (B) in the high-frequency dielectric adhesive layer.

With a volume content of the dielectric filler (B) of 3 volume % or more, insufficient heat generation can be inhibited during the dielectric heating treatment. As a result, excessive reduction in meltability of the thermoplastic resin (A) and consequent failure in obtaining strong adhesion force can be inhibited.

With a volume content of the dielectric filler (B) of 50 volume % or less, reduction in fluidity of the high-frequency dielectric heating adhesive sheet during the dielectric heating treatment and inter-electrode conduction at the time of applying a high-frequency wave are likely to be inhibited. Further, with a volume content of the dielectric filler (B) of 50 volume % or less, reduction in film-formability, flexibility, and toughness of the high-frequency dielectric heating adhesive sheet is likely to be inhibited.

It should be noted that the high-frequency dielectric adhesive layer according to the present exemplary embodiment, which contains the thermoplastic resin (A) and the dielectric filler (B), preferably contains 3 volume % or more, more preferably 10 volume % or more, further preferably 15 volume % or more of the dielectric filler (B) with respect to a total volume of the thermoplastic resin (A) and the dielectric filler (B).

The high-frequency dielectric adhesive layer according to the present exemplary embodiment preferably contains 50 volume % or less, more preferably 40 volume % or less, further preferably 35 volume % or less, further more preferably 25 volume % or less of the dielectric filler (B) with respect to the total volume of the thermoplastic resin (A) and the dielectric filler (B).

### Parts by Mass

The high-frequency dielectric adhesive layer according to the present exemplary embodiment preferably contains 5 parts by mass or more, more preferably 10 parts by mass or more, further preferably 20 parts by mass or more, further more preferably 40 parts by mass or more, still further preferably 60 parts by mass or more of the dielectric filler (B) with respect to 100 parts by mass of the thermoplastic resin (A).

The high-frequency dielectric adhesive layer according to the present exemplary embodiment preferably contains 300 parts by mass or less, more preferably 250 parts by mass or less, further preferably 200 parts by mass or less, further more preferably 150 parts by mass or less, still further preferably 100 parts by mass or less of the dielectric filler (B) with respect to 100 parts by mass of the thermoplastic resin (A).

With a content of the dielectric filler (B) of 5 parts by mass or more, insufficient heat generation of the high-frequency dielectric adhesive layer can be prevented during the dielectric heating treatment. As a result, excessive reduction in meltability of the thermoplastic resin (A) and consequent failure in obtaining strong adhesion force can be prevented.

With a content of the dielectric filler (B) of 300 parts by mass or less, reduction in fluidity of the high-frequency dielectric heating adhesive sheet during the dielectric heating treatment and inter-electrode conduction at the time of applying a high-frequency wave are likely to be inhibited. Further, with a content of the dielectric filler (B) of 300 parts by mass or less, reduction in film-formability, flexibility, and toughness of the high-frequency dielectric heating adhesive sheet is likely to be inhibited.

The high-frequency dielectric heating adhesive sheet according to the present exemplary embodiment preferably contains 80 mass % or more, more preferably 90 mass % or more, further preferably 99 mass % or more of a total mass of the thermoplastic resin (A) and the dielectric filler (B) with respect to an entire mass of the high-frequency dielectric adhesive layer.

### Additive (C)

The high-frequency dielectric adhesive layer according to the present exemplary embodiment optionally contains an additive or contains no additive.

Examples of the additive, which is optionally contained in the high-frequency dielectric adhesive layer according to the present exemplary embodiment, include a tackifier, plasticizer, wax, coloring agent, antioxidant, UV absorber, antibacterial agent, coupling agent, viscosity modifier, organic filler and inorganic filler. The organic and inorganic fillers as the additive are different from the dielectric filler as the component B.

With the use of the tackifier and plasticizer, melting properties and adhesion properties of the high-frequency dielectric adhesive layer are improvable.

Examples of the tackifier include a rosin derivative, polyterpene resin, aromatic modified terpene resin, hydride of aromatic modified terpene resin, terpene phenol resin, cumarone-indene resin, aliphatic petroleum resin, aromatic petroleum resin, and hydride of aromatic petroleum resin.

Examples of the plasticizer include a petroleum process oil, natural oil, dialkyl dibasic acid, and low-molecular-weight liquid polymer. Examples of the petroleum process oil include paraffin process oil, naphthene process oil, and aromatic process oil. Examples of the natural oil include castor oil and tall oil. Examples of the dibasic acid dialkyl include dibutyl phthalate, di-2-ethylhexyl phthalate, and dibutyl adipate. Examples of the low-molecular-weight liquid polymer include liquid polybutene and liquid polyisoprene.

When the high-frequency dielectric adhesive layer according to the present exemplary embodiment contains the additive, the high-frequency dielectric adhesive layer typically preferably contains 0.01 mass % or more, more preferably 0.05 mass % or more, further preferably 0.1 mass % or more of the additive based on the total mass of the high-frequency dielectric adhesive layer. When the high-frequency dielectric adhesive layer according to the present exemplary embodiment contains the additive, the high-frequency dielectric adhesive layer preferably contains 20 mass % or less, more preferably 15 mass % or less, further preferably 10 mass % or less of the additive based on the total mass of the high-frequency dielectric adhesive layer.

### Molding Method of High-Frequency Dielectric Adhesive Layer

The high-frequency dielectric adhesive layer according to the present exemplary embodiment can be produced by preliminarily blending the above-described components (the thermoplastic resin (A), the dielectric filler (B), and optionally the additive (C)), kneading the components using a known kneader, and molding the components through a known molding process. Examples of the kneader include an extruder and a heat roller. Examples of the molding process include extrusion molding, calender molding, injection molding, and casting molding.

### Configuration and Properties of High-Frequency Dielectric Heating Adhesive Sheet

Next, a configuration and properties other than the surface free energy and the melting point of the high-frequency dielectric heating adhesive layer will be described below.

When the high-frequency dielectric heating adhesive sheet according to the present exemplary embodiment consists of a single high-frequency dielectric adhesive layer, the configuration and properties of the high-frequency dielectric heating adhesive sheet correspond to the configuration and properties of the high-frequency dielectric adhesive layer.

A difference (T1−T2) between a melting point T1 of an adherend and a melting point T2 of the high-frequency dielectric adhesive layer is preferably 10 degrees C. or more, more preferably 20 degrees C. or more, further preferably 30 degrees C. or more, further more preferably 40 degrees C. or more.

A difference (T1−T2) between the melting point T1 of the adherend and the melting point T2 of the high-frequency dielectric adhesive layer is preferably 90 degrees C. or less, more preferably 75 degrees C. or less, further preferably 60 degrees C. or less.

It should be noted that, when the adherend is made of a material that has no melting point, the flow start temperature of the adherend measured by the method described in Example is defined as T1.

Further, when the adherend is multilayered, the melting point T1 of the adherend is a melting point of a layer having the fluorine-containing surface and contacting the high-frequency dielectric adhesive layer.

When the difference between the melting points (T1−T2) is 10 degrees C. or more, it is possible to inhibit thermal degradation of the adherend caused depending on the temperature when the thermoplastic resin is melted. When the difference between the melting points (T1−T2) is 20 degrees C., thermal deformation of the adherend can be more effectively prevented.

When the difference between the melting points (T1−T2) is 90 degrees C. or less, the high-frequency dielectric adhesive layer is more likely to exhibit excellent adhesivity to the adherend.

### Tensile Rupture Elongation

A tensile rupture elongation of the high-frequency dielectric heating adhesive sheet according to the present exemplary embodiment is preferably 10% or more, more preferably 50% or more, further preferably 80% or more.

The tensile rupture elongation of the high-frequency dielectric heating adhesive sheet according to the present exemplary embodiment is preferably 600% or less, more preferably 500% or less, further preferably 400% or less.

With a tensile rupture elongation of the high-frequency dielectric heating adhesive sheet of 10% or more, the high-frequency dielectric heating adhesive sheet is unlikely to be disadvantageously damaged by sagging of the adherend.

With a tensile rupture elongation of the high-frequency dielectric heating adhesive sheet of 600% or less, excessive elongation of the sheet during the molding process and consequent difficulty in later cutting can be restrained, exhibiting easy handleability of the sheet.

The tensile rupture elongation of the high-frequency dielectric heating adhesive sheet herein is measured in accordance with JIS K 7161-1: 2014 and JIS K 7127: 1999.

### Young's Modulus

The Young's modulus of the high-frequency dielectric heating adhesive sheet according to the present exemplary embodiment is preferably 400 MPa or more, more preferably 500 MPa or more, further preferably 600 MPa or more.

The Young's modulus of the high-frequency dielectric heating adhesive sheet according to the present exemplary embodiment is preferably 3000 MPa or less, more preferably 2000 MPa or less, further preferably 1300 MPa or less.

With a Young's modulus of the high-frequency dielectric heating adhesive sheet of 400 MPa or more, the sheet has a freestanding property and thus is easily handleable during bonding.

With a Young's modulus of the high-frequency dielectric heating adhesive sheet of 3000 MPa or less, the high-frequency dielectric heating adhesive sheet easily follows flexure of the adherend.

The Young's modulus of the high-frequency dielectric heating adhesive sheet herein is measured in accordance with JIS K 7161-1: 2014 and JIS K 7127: 1999.

### Density

The density of the high-frequency dielectric heating adhesive sheet is preferably 1.5 g/cm³ or more, more preferably 1.8 g/cm³ or more, further preferably 2.0 g/cm³ or more, further more preferably 2.2 g/cm³ or more.

The density of the high-frequency dielectric heating adhesive sheet according to the present exemplary embodiment is preferably 3.5 g/cm³ or less, more preferably 3.3 g/cm³ or less, further preferably 3.0 g/cm³ or less, further more preferably 2.7 g/cm³ or less.

With a density of the high-frequency dielectric heating adhesive sheet of 1.5 g/cm³ or more, the sheet is more easily restrained from being flapped while the sheet is molded through a roll-to-roll process.

With a density of the high-frequency dielectric heating adhesive sheet of 3.5 g/cm³ or less, the high-frequency dielectric heating adhesive sheet is not likely to sag due to self-weight, and thus peeling at an interface between the sheet and the adherend is not likely to be caused.

With a density of the high-frequency dielectric heating adhesive sheet of 3.5 g/cm³ or less, an increase in the weight of an assembly can be inhibited, thereby making it easy to improve workability during a construction work using a product provided by bonding the adherend and the high-frequency dielectric heating adhesive sheet.

The density of the high-frequency dielectric heating adhesive sheet can be measured in accordance with Method A (water displacement method) as specified in JIS K 7112: 1999.

### Flow Start Temperature

The flow start temperature of the high-frequency dielectric adhesive layer is preferably 150 degrees C. or more, more preferably 165 degrees C. or more, further preferably 180 degrees C. or more.

The flow start temperature of the high-frequency dielectric adhesive layer is preferably 300 degrees C. or less, more preferably 280 degrees C. or less, further preferably 260 degrees C. or less, further more preferably 240 degrees C. or less.

With a flow start temperature of the high-frequency dielectric adhesive layer of 150 degrees C. or more, excellent heat resistance is likely to be exhibited.

With a flow start temperature of the high-frequency dielectric adhesive layer of 300 degrees C. or less, excellent adhesivity is likely to be exhibited in a short time.

The measurement method of the flow start temperature of the high-frequency dielectric adhesive layer is as described in later-described Examples.

### Thickness

The thickness of the high-frequency dielectric adhesive layer of the present exemplary embodiment is typically preferably 10 μm or more, more preferably 50 μm or more, further preferably 100 μm or more.

The thickness of the high-frequency dielectric adhesive layer of the present exemplary embodiment is preferably 2000 μm or less, more preferably 1000 μm or less, further preferably 600 μm or less.

The high-frequency dielectric adhesive layer having a thickness of 10 μm or more can inhibit rapid decrease in the adhesion force with respect to the adherend. Further, the high-frequency dielectric adhesive layer having a thickness of 10 μm or more can conform to irregularities possibly present on an adhesion surface of the adherend, allowing the adhesion strength to be more readily exhibited.

The high-frequency dielectric adhesive layer having a thickness of 2,000 μm or less can be molded in an elongated shape and thus can be wound in a roll or used in a roll-to-roll process. Further, the high-frequency dielectric heating adhesive sheet is easily handleable in a subsequent step (e.g. punching process). Further, an entire weight of the adhered assembly (assembly) increases, as the thickness of the high-frequency dielectric adhesive layer increases. The thickness of the high-frequency dielectric adhesive layer is preferably in a range without causing any problem during actual use.

### Dielectric Property (tan δ/ε′)

The dielectric property (dielectric dissipation factor (tan δ) and permittivity (E′)) of the high-frequency dielectric heating adhesive sheet according to the present exemplary embodiment can be measured in accordance with JIS C 2138: 2007, and can also be simply and accurately measured by an impedance material method.

The dielectric property (tan δ/ε′) of the high-frequency dielectric heating adhesive sheet according to the present exemplary embodiment is preferably 0.005 or more, more preferably 0.008 or more, further preferably 0.01 or more.

The dielectric property (tan δ/ε′) of the high-frequency dielectric heating adhesive sheet according to the present exemplary embodiment is preferably 0.05 or less, more preferably 0.03 or less. The dielectric property (tan δ/ε′) is a value obtained by dividing a dielectric dissipation factor (tan δ) measured using an impedance material analyzer or the like by permittivity (ε′) measured using an impedance material analyzer or the like.

The high-frequency dielectric heating adhesive sheet whose dielectric property is 0.005 or more is likely to inhibit difficulty in firm adhesion with the adherend which may otherwise be caused by insufficient heat generation during a dielectric heating treatment.

The high-frequency dielectric heating adhesive sheet whose dielectric property is 0.05 or less can easily inhibit damage on the adherend when a high-frequency wave is applied during adhesion.

Details of the measurement method for the dielectric property of the high-frequency dielectric heating adhesive sheet are as follows. The high-frequency dielectric heating adhesive sheet is cut into pieces of a predetermined size. Then, the permittivity (ε′) and the dielectric dissipation factor (tan δ) of the pieces at 23 degrees C. and at 40.68 MHz frequency are measured using an impedance material analyzer E4991 (manufactured by Agilent Technologies, Inc.) to calculate dielectric property (tan δ/ε′) values.

### Melt Flow Rate

The Melt Flow Rate (MFR) of the high-frequency dielectric adhesive layer according to the present exemplary embodiment is preferably 1 g/10 min or more, more preferably 3 g/10 min or more, further preferably 5 g/10 min or more, further more preferably 7 g/10 min or more, especially preferably 10.0 g/10 min or more.

The MFR of the high-frequency dielectric adhesive layer according to the present exemplary embodiment is preferably 85 g/10 min or less, more preferably 55 g/10 min or less, further preferably 40 g/10 min or less, further more preferably 20 g/10 min or less.

The high-frequency dielectric adhesive layer whose MFR is 1 g/10 min or more can keep fluidity and is likely to provide film-thickness accuracy.

The high-frequency dielectric adhesive layer whose MFR is 85 g/10 min or less can easily exhibit film-formability.

The MFR of the high-frequency dielectric adhesive layer can be measured according to a method described in a corresponding item of later-described Examples.

### Softening Temperature

The softening temperature of the high-frequency dielectric heating adhesive sheet is preferably 140 degrees C. or more, more preferably 160 degrees C. or more, further preferably 180 degrees C. or more, further more preferably 200 degrees C. or more.

The softening temperature of the high-frequency dielectric heating adhesive sheet is preferably 300 degrees C. or less, more preferably 260 degrees C. or less, further preferably 240 degrees C. or less, further more preferably 220 degrees C. or less.

The high-frequency dielectric adhesive layer is likely to exhibit improved heat resistance when the softening temperature of the high-frequency dielectric heating adhesive sheet is 140 degrees C. or more. When an assembly provided by bonding an adherend and the high-frequency dielectric heating adhesive sheet according to the present exemplary embodiment is installed outdoors, the adherend and the high-frequency dielectric heating adhesive sheet are likely to be kept bonded even in a high-temperature (e.g. in mid-summer).

The high-frequency dielectric heating adhesive sheet whose softening temperature is 300 degrees C. or less is likely to exhibit a stable bonding strength in a short time.

The high-frequency dielectric heating adhesive sheet according to the present exemplary embodiment is used to be bonded to an adherend having a fluorine-containing surface. The high-frequency dielectric heating adhesive sheet according to the present exemplary embodiment is used to bond adherends to produce, for instance, an assembly.

### Assembly

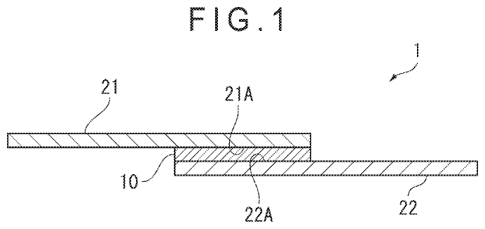

FIG. 1 is a schematic cross-sectional view of an assembly 1 according to a first aspect of the present exemplary embodiment.

The assembly 1 according to the first aspect of the present exemplary embodiment includes a first adherend 21, a high-frequency dielectric heating adhesive sheet 10, and a second adherend 22. The assembly 1 includes the high-frequency dielectric heating adhesive sheet 10 between the first adherend 21 and the second adherend 22. The assembly 1 is a bonded product provided by bonding the first adherend 21 and the second adherend 22 through the high-frequency dielectric heating adhesive sheet 10.

The high-frequency dielectric heating adhesive sheet according to the above-described exemplary embodiment can be used as the high-frequency dielectric heating adhesive sheet 10.

The first adherend 21 and the second adherend 22 are each the adherend according to the above-described exemplary embodiment. The first adherend 21 includes a fluorine-containing surface 21A (first fluorine-containing surface). The second adherend 22 includes a fluorine-containing surface 22A (second fluorine-containing surface). Although the first adherend 21 and the second adherend 22 are sheet-shaped in FIG. 1, the high-frequency dielectric heating adhesive sheet according to the invention may have any shape.

The assembly 1 is usable in applications that require at least one of weatherability, stain-proofness, chemical resistance, and heat resistance. The application of the assembly 1, which is not specifically limited, is preferably to be installed outdoors, for instance.

### Bonding Method

The adherends are preferably bonded through a dielectric heating treatment, more preferably by a bonding method including the following steps (P1) and (P2).

Step (P1): bringing the fluorine-containing surface of the adherend into contact with the high-frequency dielectric adhesive layer

Step (P2): applying a high-frequency wave to the high-frequency dielectric adhesive layer to bond the high-frequency dielectric heating adhesive sheet to the fluorine-containing surface

The step (P1) is a step for locating the high-frequency dielectric heating adhesive sheet at a predetermined place. In the present exemplary embodiment, the step (P1) is a step for holding the high-frequency dielectric heating adhesive sheet 10 between the first adherend 21 and the second adherend 22. When the first adherend 21 and the second adherend 22 are entirely made of a material containing fluorine, a surface of the first adherend 21 and a surface of the second adherend 22 correspond to the fluorine-containing surface 21A and the fluorine-containing surface 22A, respectively. Alternatively, when the first adherend 21 and/or the second adherend 22 include a part made of the fluorine-containing material and a part made of a material not containing fluorine, the fluorine-containing surface 21A and the fluorine-containing surface 22A are arranged face to face to hold the high-frequency dielectric heating adhesive sheet 10 between the fluorine-containing surface 21A and the fluorine-containing surface 22A.

The high-frequency dielectric heating adhesive sheet 10 is only necessary to be held between the first adherend 21 and the second adherend 22 so that the first adherend 21 and the second adherend 22 are bondable. It is only necessary that a part of, parts of, or an entirety of the high-frequency dielectric heating adhesive sheet 10 is held between the first adherend 21 and the second adherend 22. In order to enhance the bonding strength between the first adherend 21 and the second adherend 22, it is preferable that the high-frequency dielectric heating adhesive sheet 10 is held so that the high-frequency dielectric heating adhesive sheet 10 extends all over the bonding surfaces of the first adherend 21 and the second adherend 22. Further, in another aspect for holding the high-frequency dielectric heating adhesive sheet 10 between the first adherend 21 and the second adherend 22, the high-frequency dielectric heating adhesive sheet 10, which is frame-shaped, is placed along outer peripheries of the bonding surfaces of the first adherend 21 and the second adherend 22 to be held between the first adherend 21 and the second adherend 22. The high-frequency dielectric heating adhesive sheet 10, which is thus placed in a frame-shape, ensures the bonding strength between the first adherend 21 and the second adherend 22 and reduces the weight of the assembly 1 as compared with a case where the high-frequency dielectric heating adhesive sheet 10 is placed all over the bonding surfaces. Further, according to the aspect for partially holding the high-frequency dielectric heating adhesive sheet 10 between the first adherend 21 and the second adherend 22, the size of the used high-frequency dielectric heating adhesive sheet 10 can be reduced, so that the time for high-frequency dielectric heating can be shortened as compared with a case where the high-frequency dielectric heating adhesive sheet 10 is placed all over the bonding surfaces.

The step (P2) is a step for applying dielectric heating on the high-frequency dielectric heating adhesive sheet 10 held between the first adherend 21 and the second adherend 22 using a dielectric heating adhesion device.

The dielectric heating adhesion device used in the step (P2) and conditions for the dielectric heating treatment will be described below. Now, description will be made with reference to an example for producing the assembly 1.

### Dielectric Heating Adhesion Device

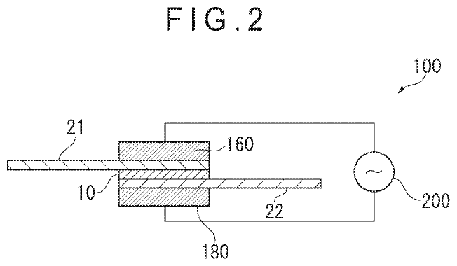

FIG. 2 schematically shows a dielectric heating adhesion device 100.

The dielectric heating adhesion device 100 includes a first high-frequency electrode 160, a second high-frequency electrode 180, and a high-frequency power source 200.

The first high-frequency electrode 160 faces the second high-frequency electrode 180. The first high-frequency electrode 160 and the second high-frequency electrode 180 include a press mechanism. The first adherend 21, the high-frequency dielectric heating adhesive sheet 10, and the second adherend 22 can be pressed between the first high-frequency electrode 160 and the second high-frequency electrode 180 by the press mechanism.

An arrangement of electrodes, in which the first high-frequency electrode 160 and the second high-frequency electrode 180 form a pair of mutually parallel flat electrodes, is sometimes referred to as a “parallel flat-plate type.”

In order to apply a high-frequency wave, a high-frequency dielectric heater of the parallel flat-plate type is also preferably used. In the parallel flat-plate type high-frequency dielectric heater, the high-frequency wave penetrates through the high-frequency dielectric heating adhesive sheet located between the electrodes to heat the entirety of the high-frequency dielectric heating adhesive sheet, thus adhering the adherend(s) and the high-frequency dielectric heating adhesive sheet in a short time.

A high-frequency power source 200 for applying a high-frequency (e.g. approx. 27.12 MHz or approx. 40.68 MHz) wave is connected to both of the first high-frequency electrode 160 and the second high-frequency electrode 180.

As shown in FIG. 2, the dielectric heating adhesion device 100 applies dielectric heating through the high-frequency dielectric heating adhesive sheet 10 held between the first adherend 21 and the second adherend 22. In addition to the dielectric heating treatment, the dielectric heating adhesion device 100 applies pressure using the first high-frequency electrode 160 and the second high-frequency electrode 180, whereby the first adherend 21 adheres to the second adherend 22.

When a high-frequency electric field is applied between the first high-frequency electrode 160 and the second high-frequency electrode 180, the dielectric filler (not shown), which is dispersed in an adhesive component of the high-frequency dielectric heating adhesive sheet 10, absorbs energy of the high-frequency wave at the overlapped portion with the first adherend 21 and the second adherend 22.

The dielectric filler as the component B serves as a heat source, and heat generated by the dielectric filler melts the thermoplastic resin as the component A. The first adherend 21 thus eventually firmly adheres to the second adherend 22 even through a short-time treatment.

Since the first high-frequency electrode 160 and the second high-frequency electrode 180 include the press mechanism, the first high-frequency electrode 160 and the second high-frequency electrode 180 also serve as a press machine. Pressure is applied in a compression direction by the first and second high-frequency electrodes 160, 180, and the high-frequency dielectric heating adhesive sheet 10 is melted by heating, whereby the first adherend 21 and the second adherend 22 can more firmly adhere to each other.

### Conditions for High-Frequency Dielectric Heating Adhesion

Conditions for high-frequency dielectric heating adhesion can be altered as necessary, but are preferably as follows.

The high-frequency output is preferably 10 W or more, more preferably 50 W or more, further preferably 100 W or more.

The high-frequency output is preferably 50,000 W or less, more preferably 20,000 W or less, further preferably 15,000 W or less, further more preferably 10,000 W or less, still further preferably 1,000 W or less.

With a high-frequency output of 10 W or more, it is unlikely to occur that the temperature is not easily raised by the dielectric heating treatment and a sufficient adhesion force cannot be obtained.

With a high-frequency output of 50,000 W or less, it is unlikely to occur that temperature control by the dielectric heating treatment is difficult.

An application time of the high-frequency wave is preferably one second or more.

The application time of the high-frequency wave is preferably 60 seconds or less, more preferably 45 seconds or less, further preferably 35 seconds or less, further more preferably 25 seconds or less, still further preferably 10 seconds or less.

With an application time of the high-frequency wave of one second or more, it is unlikely to occur that the temperature is not easily raised by the dielectric heating treatment and a sufficient adhesion force cannot be obtained.

With an application time of the high-frequency wave of 60 seconds or less, it is unlikely to occur that production efficiency of the assembly is lowered, production cost is increased, and the adherend is thermally degraded.

The frequency of the applied high-frequency wave is preferably 1 kHz or more, more preferably 1 MHz or more, further preferably 5 MHz or more, further more preferably 10 MHz or more.

The frequency of the applied high-frequency wave is preferably 300 MHz or less, more preferably 100 MHz or less, further preferably 80 MHz or less, further more preferably 50 MHz or less. Specifically, 13.56 MHz, 27.12 MHz, or 40.68 MHz, which is an industrial frequency band allocated by International Telecommunication Union, is used in the high-frequency dielectric heating adhesion method (bonding method) of the present exemplary embodiment.

### Effect of First Exemplary Embodiment

The polarity of a fluorine resin is extremely low. Accordingly, a fluorine-containing adherend cannot be bonded using a typical adhesive or a typical heat-bonding sheet. Further, the dielectric property of the fluorine resin is low. Accordingly, a fluorine-containing adherend cannot be bonded through a typical welder processing.

Using the high-frequency dielectric heating adhesive sheet according to the present exemplary embodiment for bonding with an adherend having a fluorine-containing surface can achieve firm bonding therebetween without applying a pretreatment on the surface of the adherend.

Further, when the component A is selected to make the difference between the melting point of the high-frequency dielectric adhesive layer and the melting point of an adherend a predetermined value or more, it is possible to inhibit a damage on the adherend caused by heat.

The high-frequency dielectric heating adhesive sheet according to the present exemplary embodiment is easier to handle and provides improved workability during bonding with an adherend as compared with a case where an adhesive that requires some application process is used. The high-frequency dielectric heating adhesive sheet according to the present exemplary embodiment is bondable with an adherend by applying a high-frequency wave for a short time.

The high-frequency dielectric heating adhesive sheet according to the present exemplary embodiment is excellent in terms of water resistance and moisture resistance as compared with a typical adhesive.

Since the high-frequency dielectric heating adhesive sheet according to the present exemplary embodiment does not contain any solvent, it is not likely to cause a problem associated with Volatile Organic Compounds (VOC) derived from an adhesive used for bonding with an adherend. Accordingly, the assembly using the high-frequency dielectric heating adhesive sheet according to the present exemplary embodiment for bonding with the adherend is suitable for architecture or the like.

Since the high-frequency dielectric heating adhesive sheet according to the present exemplary embodiment is heated through high-frequency dielectric heating, an adherend is only locally heated at a surface in contact with the high-frequency dielectric heating adhesive sheet. Accordingly, the high-frequency dielectric heating adhesive sheet according to the present exemplary embodiment can eliminate a problem of melting the entire adherend when the sheet is bonded with the adherend.

According to the adhering method using the high-frequency dielectric heating adhesive sheet according to the present exemplary embodiment, only a predetermined part can be locally heated from an outside using a dielectric heating adhesion device. Accordingly, even when the adherend is a large-sized and complex three-dimensional assembly, a thick and complex three-dimensional structure or the like and high dimensional accuracy is required, the bonding method using the high-frequency dielectric heating adhesive sheet according to the present exemplary embodiment is effective.

In addition, the thickness and the like of the high-frequency dielectric heating adhesive sheet according to the present exemplary embodiment can be controlled, as desired. Accordingly, the high-frequency dielectric heating adhesive sheet according to the present exemplary embodiment can be used in a roll-to-roll process. Further, the high-frequency dielectric heating adhesive sheet can be processed (e.g. punching) into desired dimensions and shape in accordance with an adhesion area with an adherend and the shape of the adherend. Thus, the high-frequency dielectric heating adhesive sheet according to the present exemplary embodiment is also advantageous in terms of production process.

### Modification of Exemplary Embodiment

The scope of the invention is not limited by the above-described exemplary embodiment. The invention includes modification(s) and improvement(s) compatible with an object of the invention.

The high-frequency dielectric heating adhesive sheet optionally includes a sticky portion. The presence of the sticky portion inhibits a positional misalignment of the high-frequency dielectric heating adhesive sheet when the high-frequency dielectric heating adhesive sheet is held between adherends, allowing accurate positioning of the sheet. The sticky portion may be provided only on one side or on both sides of the high-frequency dielectric adhesive layer. The sticky portion may be provided all over or on a part of the side(s) of the high-frequency dielectric adhesive layer.

Further, a hole(s), protrusion(s), or the like for temporary fixation is optionally provided on a part of the high-frequency dielectric heating adhesive sheet. The presence of the hole(s), protrusion(s) or the like for temporary fixation inhibits a positional misalignment of the high-frequency dielectric heating adhesive sheet when the high-frequency dielectric heating adhesive sheet is bonded with an adherend, allowing accurate positioning of the sheet.

In the bonding method using the high-frequency dielectric heating adhesive sheet, it is also preferable that an adherend and another adherend different from the adherend are bonded through the high-frequency dielectric adhesive layer. In this case, the another adherend preferably has a fluorine-containing surface that contains at least fluorine on a surface thereof. Examples of the combination of the adherend and the another adherend include, for instance, the combination of the first adherend and the second adherend in the above-described exemplary embodiment and a combination of the first adherend, the second adherend and a third adherend. Four or more adherends can be bonded by the bonding method.

The assembly produced by the bonding method using the high-frequency dielectric heating adhesive sheet is not limited to the arrangement as shown in FIG. 1.

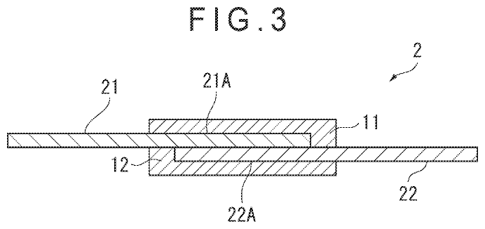

For instance, the assembly may be an assembly 2 shown in FIG. 3. The assembly 2, which is different from the assembly 1 including the high-frequency dielectric heating adhesive sheet 10 held between the first adherend 21 and the second adherend 22, includes a first high-frequency dielectric heating adhesive sheet 11 and a second high-frequency dielectric heating adhesive sheet 12 holding the first adherend 21 and the second adherend 22 therebetween. The first high-frequency dielectric heating adhesive sheet 11 and the second high-frequency dielectric heating adhesive sheet 12 are preferably the high-frequency dielectric heating adhesive sheet described in the first exemplary embodiment.

The assembly 2 can be produced as follows. The first adherend 21 is overlapped with the second adherend 22 such that the fluorine-containing surface 21A of the first adherend 21 and the fluorine-containing surface 22A of the second adherend 22 face outward. Then, the first high-frequency dielectric heating adhesive sheet 11 and the second high-frequency dielectric heating adhesive sheet 12 are respectively attached on the fluorine-containing surface 21A and the fluorine-containing surface 22A. After that, a high-frequency wave is applied to produce the assembly 2.

The number of the adherends used in the bonding method using the high-frequency dielectric heating adhesive sheet is not specifically limited.

A bonding structure of an adherend according to an aspect different from the above exemplary embodiment may be a bonding structure in which three or more adherends adhere to each other. For instance, when three adherends (the first adherend, the second adherend, and a third adherend) are adhered, the second adherend and the third adherend may be arranged side by side to face the first adherend, the first high-frequency dielectric heating adhesive sheet may be held between the first adherend and the second adherend, and the second high-frequency dielectric heating adhesive sheet may be held between the first adherend and the third adherend. More specifically, the second adherend and the third adherend may be laid side by side with respect to the first adherend.

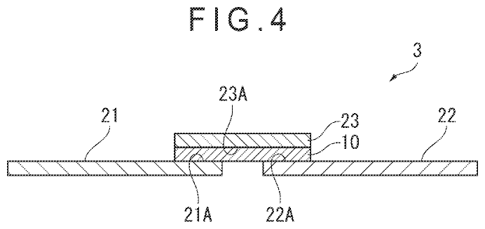

Alternatively, a single high-frequency dielectric heating adhesive sheet may be placed across the first adherend and the second adherend so that the single high-frequency dielectric heating adhesive sheet is held between the third adherend and the first and second adherends. An example of such a structure is an assembly 3 shown in FIG. 4. The assembly 3 includes the first adherend 21, the second adherend 22, a third adherend 23, and the high-frequency dielectric heating adhesive sheet 10. The high-frequency dielectric heating adhesive sheet 10 extends over the first adherend 21 and the second adherend 22. Further, the third adherend 23 is located on a side of the high-frequency dielectric heating adhesive sheet 10 opposite to the side facing the fluorine-containing surface 21A and the fluorine-containing surface 22A. The third adherend 23, which has a fluorine-containing surface 23A (third fluorine-containing surface), is disposed such that the fluorine-containing surface 23A faces the high-frequency dielectric heating adhesive sheet 10. The assembly 3, in which the single high-frequency dielectric heating adhesive sheet 10 is held between the third adherend 23 and the first and second adherends 21, 22, can firmly connect the first adherend 21 and the second adherend 22. In addition, for instance, when a single adherend is torn into two pieces, the bonding method is optionally applied to bond the torn adherends (the first adherend and the second adherend) using a repair member corresponding to the third adherend. Furthermore, the bonding method is also applicable to an adherend(s) with a defect, where a repair member corresponding to the third adherend is bonded to cover the defect.

The high-frequency dielectric heating treatment does not necessarily use the dielectric heating adhesion device provided with oppositely installed electrodes as described in the exemplary embodiment, but a lattice-electrode high-frequency dielectric heater is alternatively usable. The lattice-electrode high-frequency dielectric heater includes a lattice electrode including first electrodes and second electrodes whose polarity is reverse to that of the first electrodes, the first and second electrodes being alternately arranged at constant intervals in the same surface.

For instance, when the assembly 1 as shown in FIG. 1 is to be produced, the lattice-electrode high-frequency dielectric heater is disposed to face the first adherend 21 or the second adherend 22 to apply a high-frequency wave.

When the lattice-electrode high-frequency dielectric heater is used to produce the assembly, the lattice electrode (the first and second lattice electrodes) is optionally disposed on respective sides of the assembly to simultaneously apply a high-frequency wave from both sides.

For instance, when the assembly 1 is to be produced, the first and the second lattice electrodes are optionally disposed to face the first adherend 21 and the second adherend 22, respectively, to simultaneously apply the high-frequency wave.

When the lattice-electrode high-frequency dielectric heater is used to produce the assembly, the lattice electrode is optionally disposed on one side of the assembly to apply a high-frequency wave and, subsequently, disposed on the other side of the assembly to apply the high-frequency wave.

For instance, when the assembly 1 is to be produced, the lattice electrode is optionally disposed to face the first adherend 21 to apply the high-frequency wave and, subsequently, disposed to face the second adherend 22 to apply the high-frequency wave.

In order to apply a high-frequency wave, the lattice-electrode high-frequency dielectric heater is also preferably used. The use of the lattice-electrode high-frequency dielectric heater allows adherends to adhere to each other through dielectric heating without being affected by the thickness of the assembly from a surface layer of the assembly (e.g. from the surface layer close to the high-frequency dielectric heating adhesive sheet). Further, the use of the lattice-electrode high-frequency dielectric heater reduces the energy required for producing the assembly.

It should be noted that an aspect using the dielectric heating adhesion device provided with oppositely disposed electrodes is exemplary shown in the drawing for the purpose of simplification.

### EXAMPLES

The invention will be described below in more detail with reference to Examples. It should however be noted that the scope of the invention is by no means limited by the Examples.

### Preparation of High-Frequency Dielectric Heating Adhesive Sheet

### Example 1

A fluorinated thermoplastic resin (product name “NEOFLON EFEP RP-5000” manufactured by DAIKIN INDUSTRIES, LTD.) of 80.0 volume % as the component A and zinc oxide (product name “LPZINC11”, average particle size: 11 μm (denoted by ZnO in Table 1) manufactured by SAKAI CHEMICAL INDUSTRY CO., LTD.) of 20.0 volume % as the component B were put into a vessel after being weighed. Table 1 shows physical properties of the resin used as the component A. Table 2 shows a blend ratio of the components in the high-frequency dielectric adhesive layer. In Table 2, the blend ratio of the components is a value represented by volume %.

The weighed components A and B were preliminarily blended in the vessel. The preliminarily blended components were supplied into a hopper of a twin screw extruder having a 30-mm-diameter screw. Then, the components were melted and kneaded at a cylinder setting temperature in a range from 210 to 230 degrees C. and die temperature of 230 degrees C., and were subsequently pelletized using a pelletizer.

Subsequently, the resultant pellets were loaded into a hopper of a single screw extruder provided with a T-die. Then, a sheet-shaped melted and kneaded substance was extruded from the T-die (cylinder temperature: 230 degrees C., die temperature: 230 degrees C.) and was cooled by a cooling roller to produce a 400-μm thick high-frequency dielectric heating adhesive sheet.

### High-Frequency Adhesivity

Two fluorine resin sheets as adherends were adhered using the resultant high-frequency dielectric heating adhesive sheet under high-frequency-wave application conditions below to obtain an assembly according to Example 1. The fluorine resin sheet was NEOFLON EF-0100 (melting point: 250 degrees C.) manufactured by DAIKIN INDUSTRIES, LTD. The size of the fluorine resin sheet was 25 mm×100 mm×0.1 mm.

### High-Frequency-Wave Application Conditions

The resultant high-frequency dielectric heating adhesive sheet was held between the fluorine resin sheets and was applied with a high-frequency wave (frequency 40.68 MHz, output 400 W) for 20 seconds while being fixed between electrodes of a high-frequency dielectric heater (YRP-400T-A manufactured by YAMAMOTO VINITA CO., LTD.) to prepare a test piece.

### Examples 2 to 6

Assemblies (test pieces) of Examples 2 to 6 were produced in the same manner as in Example 1 except that: the type and content of the component A, the content of the component B, the thickness of the high-frequency dielectric heating adhesive sheet were changed as shown in Table 2 below; and kneading temperature and film-forming temperature were adjusted as necessary.

The component A in Example 6 was “AH-2000” (product name) manufactured by AGC Inc.

### Comparative 1

An assembly (test piece) of Comparative 1 was produced in the same manner as in Example 1 except that the type of the component A was changed as shown in Table 2 below and kneading and film-forming temperatures were adjusted as necessary.

The thermoplastic resin used in Comparative 1 was ethylene-vinyl acetate copolymer (EVAFLEX EV560 manufactured by DuPont Mitsui Polychemicals Co., LTD.).

### Evaluation of High-Frequency Dielectric Heating Adhesive Sheet

### Adhesivity Test (Tensile Shear Strength)

A tensile shear strength of the test piece obtained in the above-described test for high-frequency adhesivity was measured using a versatile tensile tester (INSTRON 5581 manufactured by Instron Ltd.) with a tensile speed of 100 mm/min. Further, a breaking mode of the test piece during the measurement of the tensile shear strength was observed to evaluate the adhesion force in accordance with the criteria below. The measurement of the tensile shear strength was measured in accordance with JIS K 6850: 1999.

When the breaking mode was a material fracture or interface fracture (0.1 MPa or more), the adhesion force was evaluated as “A,” and the breaking mode other than that was evaluated as “F.”

### Surface Free Energy

The surface free energy (mJ/m²) of the high-frequency dielectric adhesive layer was calculated according to the Kitazaki-Hata theory based on measurements of contact angles (measurement temperature: 25 degrees C.) of various liquid drops.

The surface free energy (mJ/m²) was specifically obtained as follows. Initially, the contact angles (measurement temperature: 25 degrees C.) of diiodomethane, 1-bromonaphthalene, and distilled water in a form of liquid drops were measured using DM-70 manufactured by Kyowa Interface Science Co., Ltd. according to Sessile drop method as specified by JIS R 3257: 1999. Then, the surface free energy (mJ/m²) was calculated according to the Kitazaki-Hata theory based on the measurements of the contact angles.

### Tensile Rupture Elongation and Young's Modulus

The high-frequency dielectric heating adhesive sheets produced in the above Examples and Comparative were cut into test pieces of 15 mm (in TD (Transverse Direction))×150 mm (in MD (Machine Direction)), and tensile rupture elongation (%) and Young's modulus (MPa) of the test pieces at 23 degrees C. were measured in accordance with JIS K 7161-1: 2014 and JIS K 7127: 1999. Specifically, after the test piece was set in a tensile tester (“Autograph AG-IS 500N” manufactured by Shimadzu Corporation) at a distance between chucks of 100 mm, a tensile test was performed at a speed of 200 mm/min to measure the tensile rupture elongation (%) and Young's modulus (MPa).

### Softening Temperature and Flow Start Temperature

The softening temperature and the flow start temperature of the thermoplastic resin and the high-frequency dielectric heating adhesive sheet used or produced in Examples and Comparative were measured using a drop flow tester (model No. CFT-100D manufactured by Shimadzu Corporation). A stroke displacement rate (mm/min) that changed depending on rising temperature was measured at a load of 5 kg and a sample-temperature-increase rate of 10 degrees C./min using a die (hole diameter 2.0 mm, hole length: 5.0 mm) and a cylinder (inner diameter 11.329 mm) to obtain a temperature-dependent chart of the stroke displacement rate of the measurement sample. In this chart, a peak-top temperature on a low-temperature side was determined as the softening temperature.

Further, a temperature, at which the stroke-displacement rate increased again after passing through the peak of the softening temperature, was determined as the flow start temperature.

### Melt Flow Rate

The MFR of the measurement sample was measured under test conditions as specified in JIS K 7210-1: 2014, which were modified as follows.
Test temperature: 230 degrees C.
Load: 5 kg
Die: hole shape 2.0 mm diameter, length 5.0 mm
Cylinder diameter: 11.329 mm

### Melting Point

The melting point was measured in accordance with JIS K 7121: 2012 using a Differential Scanning Calorimeter (DSC, product name “Q2000” manufactured by TA Instruments Inc.).

Specifically, the measurement sample was heated from a normal temperature to 250 degrees C. at a temperature-increase rate of 20 degrees C./min, held at 250 degrees C. for 10 minutes, lowered to −60 degrees C. at a temperature-decrease rate of 20 degrees C./min, and was held at −60 degrees C. for 10 minutes. Subsequently, the measurement sample was again heated to 250 degrees C. at a temperature-increase rate of 20 degrees C./min to obtain a DSC curve, thereby measuring the melting point.

### Density

The density (g/cm³) of the high-frequency dielectric heating adhesive sheet and the thermoplastic resin was measured in accordance with Method A (water displacement method) of JIS K 7112: 1999.

### Dielectric Property

The prepared high-frequency dielectric heating adhesive sheet was cut into pieces of 30 mm×30 mm. The permittivity (E′) and the dielectric dissipation factor (tan δ) of the cut pieces of the high-frequency dielectric heating adhesive sheet were measured at 23 degrees C. and 40.68 MHz frequency using an impedance material analyzer E4991 (manufactured by Agilent Technologies, Inc.). The value of the dielectric property (tan δ/ε′) was calculated based on the results of the measurement.

TABLE 1

| | Thermoplastic Resin | | |
|---|---|---|---|
| | Material | | |
| | ETFE | | EVA |
| Product Name | RP-5000 | AH-2000 | EV560 |
| Melting Point [° C.] | 197 | 238 | 90 |
| Softening | 204 | 259 | 73 |
| Temperature [° C.] | | | |
| Flow Start | 213 | 300< | 99 |
| Temperature [° C.] | | | |
| Density [g/cm³] | 1.76 | 1.78 | 0.93 |

TABLE 2

| | Composition of High-Frequency | | | | | | | | |
|---|---|---|---|---|---|---|---|---|---|
| | Dielectric Adhesive Layer [volume %] | | | | | | | | |
| | | | | (B) | | | | | |
| | (A) | | | Dielectric | | | | | |
| | Thermoplastic Resin | | | Filler | High-Frequency Dielectric Heating Adhesive Sheet | | | | |
| | Material | | | | (High-Frequency Dielectric Adhesive Layer) | | | | |
| | ETFE | | EVA | Zinc Oxide | Sheet | Surface Free | Melting | | MFR |
| | Product Name | | | | Thickness | Energy | Point | T1 − T2 | [g/10 min] |
| | RP-5000 | AH-2000 | EV560 | LPZINC11 | [μm] | [mJ/m²] | [° C.] | [° C.] | @230° C. |
| Ex. 1 | 80.0 | — | — | 20.0 | 400 | 21.0 | 198 | 52 | 17.1 |
| Ex. 2 | 95.0 | — | — | 5.0 | 400 | 18.0 | 197 | 53 | 16.8 |
| Ex. 3 | 60.0 | — | — | 40.0 | 400 | 23.0 | 196 | 54 | 15.6 |
| Ex. 4 | 80.0 | — | — | 20.0 | 300 | 22.0 | 198 | 52 | 17.1 |
| Ex. 5 | 80.0 | — | — | 20.0130 | 500 | 20.0 | 197 | 53 | 17.1 |
| Ex. 6 | — | 80.0 | — | 20.0 | 400 | 21.0 | 239 | 11 | N/A |
| Comp. 1 | — | — | 80.0 | 20.0 | 400 | 34.0 | 90 | 160 | 26.6 |

| | High-Frequency Dielectric Heating Adhesive Sheet | | | | | | |
|---|---|---|---|---|---|---|---|
| | (High-Frequency Dielectric Adhesive Layer) | | | | | | |
| | | Flow | Tensile | | | | |
| | Softening | Start | Rupture | Young's | | Dielectric | Evaluation |
| | Temperature | Temperature | Elongation | Modullus | Density | Property | Adhesivity |
| | [° C.] | [° C.] | [%] | [MPa] | [g/cm³] | [tan δ/ε] | Test |
| Ex. 1 | 210 | 215 | 102 | 1120 | 2.53 | 0.025 | A |
| Ex. 2 | 208 | 217 | 448 | 624 | 1.95 | 0.012 | A |
| Ex. 3 | 206 | 220 | 20 | 2232 | 3.30 | 0.027 | A |
| Ex. 4 | 210 | 215 | 79 | 1107 | 2.53 | 0.024 | A |
| Ex. 5 | 210 | 215 | 126 | 1040 | 2.53 | 0.026 | A |
| Ex. 6 | 235 | >300 | 16 | 1119 | 2.55 | 0.025 | A |
| Comp. 1 | 95 | 105 | 89 | 125 | 1.87 | 0.027 | F |

It is found that the high-frequency dielectric heating adhesive sheets according to Examples 1 to 6 can more firmly bond the fluorine resin sheets as compared with the sheet according to Comparative 1.

Further, the high-frequency dielectric heating adhesive sheets according to Examples 1 to 5 did not deform the fluorine resin sheets (adherends) in producing the test pieces. The fluorine resin sheets were deformed when the test piece was produced using the high-frequency dielectric heating adhesive sheet according to Example 6.

### EXPLANATION OF CODES

1 . . . assembly, 10 . . . high-frequency dielectric adhesive layer (high-frequency dielectric heating adhesive sheet), 11 . . . first high-frequency dielectric heating adhesive sheet, 12 . . . second high-frequency dielectric heating adhesive sheet, 2 . . . assembly, 21 . . . first adherend, 21A . . . fluorine-containing surface, 22 . . . second adherend, 22A . . . fluorine-containing surface, 23 . . . third adherend, 23A . . . fluorine-containing surface, 3 . . . assembly

1. A bonding method for bonding an adherend with a high-frequency dielectric heating adhesive sheet, wherein
the adherend comprises a fluorine-containing surface that contains at least fluorine on a surface thereof,
the high-frequency dielectric heating adhesive sheet comprises a high-frequency dielectric adhesive layer,
the high-frequency dielectric adhesive layer comprises a thermoplastic resin (A) and a dielectric filler (B),
a surface free energy of the high-frequency dielectric adhesive layer is in a range from 15 mJ/m² to 30 mJ/m², and
a melting point of the high-frequency dielectric adhesive layer is in a range from 110 degrees C. to 300 degrees C.,
the method comprising:
bringing the fluorine-containing surface of the adherend into contact with the high-frequency dielectric adhesive layer; and
applying a high-frequency wave to the high-frequency dielectric adhesive layer to bond the high-frequency dielectric heating adhesive sheet to the fluorine-containing surface.

2. The bonding method according to claim 1, wherein the dielectric filler (B) is zinc oxide.

3. The bonding method according to claim 1, wherein the thermoplastic resin (A) is a fluorinated thermoplastic resin containing fluorine.

4. The bonding method according to claim 1, wherein a content of the dielectric filler (B) in the high-frequency dielectric adhesive layer is in a range from 3 volume % to 50 volume %.

5. The bonding method according to claim 1, wherein a difference T1−T2 between a melting point T1 of the adherend and a melting point T2 of the high-frequency dielectric adhesive layer is in a range from 10 degrees C. to 90 degrees C.

6. The bonding method according to claim 1,
wherein a tensile rupture elongation of the high-frequency dielectric heating adhesive sheet is in a range from 10% to 600%.

7. The bonding method according to claim 1, wherein Young's modulus of the high-frequency dielectric heating adhesive sheet is in a range from 400 MPa to 3000 MPa.

8. The bonding method according to claim 1, wherein a density of the high-frequency dielectric heating adhesive sheet is in a range from 1.5 g/cm³ to 3.5 g/cm³.

9. The bonding method according to claim 1, wherein a thickness of the adherend is in a range from 0.01 mm to 2 mm.

10. The bonding method according to claim 1, wherein the adherend and another adherend different from the adherend are bonded through the high-frequency dielectric adhesive layer.

11. The bonding method according to claim 10, wherein the another adherend also comprises a fluorine-containing surface that contains at least fluorine on a surface thereof.

12. The bonding method according to claim 1, wherein a high-frequency wave in a range from 1 kHz to 300 MHz is applied to the high-frequency dielectric adhesive layer.

13. The bonding method according to claim 1, wherein an application time of the high-frequency wave is in a range from one second to 60 seconds.

14. The bonding method according to claim 1, wherein a bonded product provided by bonding the adherend and the high-frequency dielectric heating adhesive sheet is used outdoors.

15. (canceled)
